(19) United States
(12) Patent Application Publication
(10) Pub. No.: US 2016/0144610 A1
(43) Pub. Date: May 26, 2016

(54) INTAGLIO PRINTING MACHINE AND INTAGLIO PRINTING METHOD

(71) Applicant: KOMORI CORPORATION, Tokyo (JP)

(72) Inventors: Isao KOMURO, Tsukuba-shi (JP); Hiroyuki ARAI, Tsukuba-shi (JP); Seiya TAMURA, Tsukuba-shi (JP)

(73) Assignee: KOMORI CORPORATION, Tokyo (JP)

(21) Appl. No.: 14/900,076

(22) PCT Filed: May 26, 2014
(86) PCT No.: PCT/JP2014/063782

§ 371 Date: Dec. 18, 2015

(30) Foreign Application Priority Data
Jun. 20, 2013 (JP) 2013-129340
Jun. 20, 2013 (JP) 2013-129341

(51) Int. Cl. B41F 9/06

(52) U.S. Cl. CPC B41F 9/063

(57) ABSTRACT

An intaglio printing machine provided with a plate cylinder (14), a wiping roller (19), an impression cylinder (13), and ink devices (17) for directly or indirectly supplying ink (I) from ink fountain devices (25) to the plate cylinder (14), and in which the ink devices (17) are provided with an ink fountain device (25) equipped with: an ink fountain roller (26); an ink-fountain-roller driving motor (42); an ink fountain (30) for storing ink (I); an ink fountain key (33), which is supported on the front end of the ink fountain (30) so as to move freely and is for adjusting the gap (G) between the ink fountain (30) and the ink fountain roller (26); and an ink-fountain-key adjusting motor (43) for adjusting amount of movement of the ink fountain key (33). The intaglio printing machine is provided with a control device (40) for controlling the ink-fountain-key adjusting motor (43) and ink-fountain-roller driving motor (42) so that prior to printing on a sheet (W), the ink fountain key (33) is closed and the ink fountain roller (26) is rotated.

### TECHNICAL FIELD

The present invention relates to an intaglio printing press and an intaglio printing method. The present invention relates more specifically to an intaglio printing press including an ink fountain device in an inking device configured to supply ink onto an intaglio cylinder, and to an intaglio printing method of printing a sheet by supplying ink from an ink fountain onto an intaglio cylinder through an ink fountain roller.

### BACKGROUND ART

An intaglio printing press of this type is disclosed in Patent Document 1, for example.

It includes an ink fountain roller which is rotatably supported on an eccentric bearing, and a bottom plate (ink fountain keys) which is provided at such a position that the front end thereof is located in the proximity of the ink fountain roller and which forms a gap between this front end and the peripheral surface of the ink fountain roller to supply ink. By turning the eccentric bearing with ink-fountain-roller moving means, the gap between the ink fountain roller and each ink fountain key can be adjusted by the same amount at once. In this way, the amount of ink to be supplied from the ink fountain onto the ink fountain roller can be adjusted in a short period of time, and wasted sheets can be reduced as well.

### PRIOR ART DOCUMENT

### Patent Document

Patent Document 1: Japanese Patent Application Publication No. 2006-321129

### SUMMARY OF THE INVENTION

### Problem to be Solved by the Invention

Meanwhile, in the intaglio printing press, during printing, ink oozes from the position in the ink fountain device where the ink fountain key and the ink fountain roller face each other, and the ink hardens. When the printing is stopped, that ink combines with the ink on the ink fountain roller and is thereby formed as an ink residue. In the case of intaglio printing, particularly indirect intaglio printing using an ink collecting cylinder, low viscosity ink is used. For this reason, starting printing with the above an ink residue formed on the ink fountain roller leads to a problem in that a portion with uneven ink film thicknesses is formed due to the ink residue, thereby deteriorating the printing quality. Note that a similar problem will occur also in direct intaglio printing using no ink collecting cylinder if low viscosity ink is used.

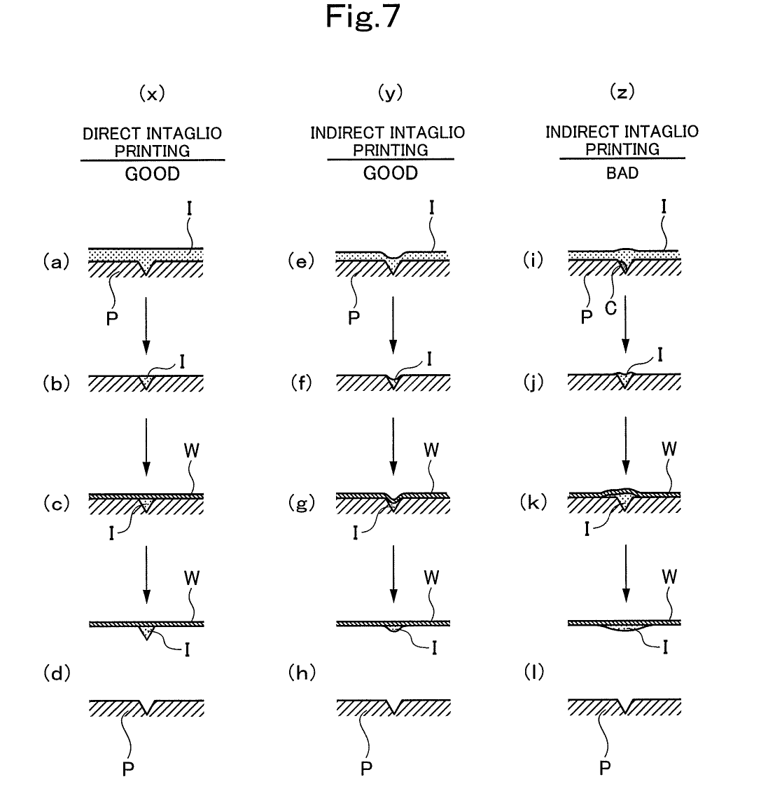

How the above poor printing occurs will be described with reference to FIG. 7. FIG. 7 shows situations in each of which ink I supplied onto a plate P from an inking device not shown is transferred (printed) onto a sheet (paper sheet) W. Here, Parts (a), (e), and (i) of FIG. 7 show a step where the ink I is supplied onto the plate P from the inking device; Parts (b), (f), and (j) of FIG. 7 show a step where the plate P is wiped by a wiping roller not shown; Parts (c), (g), and (k) of FIG. 7 show a step where the ink I remaining inside a groove in the plate P is transferred onto the sheet W; and Parts (d), (h), and (l) of FIG. 7 show a step where the sheet W with the ink I transferred thereon is separated from the plate P.

As can be seen from FIG. 7, in a case (x) where direct intaglio printing is performed using high viscosity ink, the ink I supplied on the plate P is finely wiped and thereby neatly remains inside the groove (image portion) in the plate P (see the steps from Parts (a) to (b)). This remaining ink I is finely transferred onto the sheet W (see the steps from Parts (b) to (c) to (d)).

On the other hand, in cases (y) and (z) where indirect intaglio printing is performed using low viscosity ink, the following occurs. Specifically, in the case (y) where no ink residue is formed on the ink fountain roller of the ink fountain device, the ink I remains substantially neatly inside the groove in the plate P when wiped and is transferred finely onto the sheet W by going through the “good” steps from Parts (e) to (f) to (g) to (h). However, in the case (z) where, in Part (i), an ink residue C, which is hardened high viscosity ink, is formed in the groove (image portion) in the plate P, poor printing occurs as a result of going through the “bad” steps from Parts (j) to (k) to (l). Specifically, in the step in Part (j), the wiping cannot be done finely with the wiping roller for low viscosity ink and, with the ink residue C, a larger portion of the ink I remains inside the groove in the plate P. The ink I then sticks out from the groove in the plate P and is transferred as is onto the sheet W in the steps from Parts (k) to (l). This results in a blur image and thus poor printing.

In view of the above, an object of the present invention is to provide an intaglio printing press and an intaglio printing method capable of effectively solving problems caused by ink residues in an ink fountain device before the sheet is printed.

### Means for Solving the Problem

To achieve the above object, an intaglio printing press according to the present invention is an intaglio printing press, including

an intaglio cylinder on which a plate is mounted,

a wiping roller configured to wipe an excess portion of ink on the plate by contacting the plate on the intaglio cylinder,

an impression cylinder configured to print a sheet by facing the intaglio cylinder, and

an inking device configured to supply ink directly or indirectly onto the intaglio cylinder,

the inking device including

an ink fountain roller,

ink-fountain-roller driving means for rotationally driving the ink fountain roller,

an ink fountain a front end of which faces the ink fountain roller and which is configured to store ink in cooperation with a peripheral surface of the ink fountain roller,

an ink fountain key movably supported on the front end of the ink fountain and configured to adjust a gap between the ink fountain key and the ink fountain roller, and

ink-fountain-key adjusting means for adjusting an amount of movement of the ink fountain key,

characterized in that the intaglio printing press comprises a control device configured to control the ink-fountain-key adjusting means and the ink-fountain-roller driving means before the sheet is printed, in such a way as to rotationally drive the ink fountain roller with the ink fountain key closed.

The intaglio printing press may be characterized in that the intaglio printing press is an indirect intaglio printing press comprising:

a plurality of chablon rollers onto which ink is transferred from the inking device; and

an ink collecting cylinder configured to transfer the ink from the plurality of chablon rollers onto the intaglio cylinder.

The intaglio printing press may be characterized in that the intaglio printing press further comprises a form-roller throw-on and throw-off device configured to throw form rollers on and off the chablon rollers, and

the control device controls the form-roller throw-on and throw-off device in such a way as to throw the form rollers off the chablon rollers, when rotationally driving the ink fountain roller with the ink fountain key closed before printing is started.

The intaglio printing press may be characterized in that the control device controls the ink-fountain-key adjusting means and the ink-fountain-roller driving means during printing in such a way as to rotate the ink fountain roller with the ink fountain key moved to a proximity of the ink fountain roller.

The intaglio printing press may be characterized in that

the intaglio printing press further comprises an input switch configured to start collection of ink, and

the control device controls the ink-fountain-key adjusting means and the ink-fountain-roller driving means based on the input switch.

The intaglio printing press may be characterized in that

the intaglio printing press further comprises a counter configured to count the number of printed sheets, and

the control device controls the ink-fountain-key adjusting means and the ink-fountain-roller driving means based on the counter.

The intaglio printing press may be characterized in that

the intaglio printing press further comprises a film thickness detector configured to detect an ink film thickness on the roller of the inking device,

the control device controls the ink-fountain-key adjusting means and the ink-fountain-roller driving means based on the film thickness detector.

The intaglio printing press may be characterized in that

the intaglio printing press further comprises a check device configured to check a printed sheet, and

the control device controls the ink-fountain-key adjusting means and the ink-fountain-roller driving means based on the check device.

To achieve the above object, an intaglio printing method according to the present invention is an intaglio printing method of printing a sheet by supplying ink from an ink fountain onto an intaglio cylinder through an ink fountain roller while passing the sheet between the intaglio cylinder and an impression cylinder facing the intaglio cylinder, characterized in that the intaglio printing method comprises rotationally driving the ink fountain roller while closing an ink fountain key before the sheet is printed, the ink fountain key being configured to adjust a gap between the ink fountain key and the ink fountain roller.

The intaglio printing method may be characterized in that the intaglio printing method further comprises rotationally driving the ink fountain roller while moving the ink fountain key to a proximity of the ink fountain roller during printing.

### Effects of the Invention

In the intaglio printing press according to the present invention, the ink fountain roller is rotationally driven for a predetermined period of time with the ink fountain key in the ink fountain device closed (the amount of opening of the ink fountain key is set to zero) after the printing press is operated but before the sheet is printed. In this way, the ink on the rollers in the inking device is returned into the ink fountain (this will be referred to as “fountain return”) and the ink on the ink fountain roller can therefore be thinly leveled (reset). Hence, when the sheet is subsequently printed, fine printing is done owing to the even ink film thickness. That is, problems caused by ink residues formed on the ink fountain roller are solved.

Moreover, in the intaglio printing press according to the present invention, the ink fountain roller is rotationally driven for a predetermined period of time with the ink fountain key in the ink fountain device moved to the proximity of the ink fountain roller (the amount of opening of the ink fountain key is set to zero) when the ink film thickness in the inking device exceeds a predetermined thickness during normal operation of the printing press. In this way, the ink on the rollers of the inking device is collected into the ink fountain (this will be referred to as “fountain return”) and the ink on the rollers of the inking device can therefore be thinly leveled (reset). Hence, in the following printing, the sheet is finely printed owing to the even ink film thickness. In addition, wasteful consumption of the ink is prevented as well.

In the intaglio printing method according to the present invention, the ink fountain roller is rotationally driven for a predetermined period of time with the ink fountain key in the ink fountain device closed (the amount of opening of the ink fountain key is set to zero) after the printing press is operated but before the sheet is printed. In this way, the ink on the rollers in the inking device is returned into the ink fountain and the ink on the ink fountain roller can therefore be thinly leveled (reset). Hence, when the sheet is subsequently printed, fine printing is done owing to the even ink film thickness. That is, problems caused by ink residues formed on the ink fountain roller are solved.

Moreover, in the intaglio printing press according to the present invention, the ink fountain roller is rotationally driven for a predetermined period of time with the ink fountain key in the ink fountain device moved to the proximity of the ink fountain roller (the amount of opening of the ink fountain key is set to zero) when the ink film thickness in the inking device exceeds a predetermined thickness during normal operation of the printing press. In this way, the ink on the rollers of the inking device is collected into the ink fountain and the ink on the rollers of the inking device can therefore be thinly leveled (reset). Hence, in the following printing, the sheet is finely printed owing to the even ink film thickness. In addition, wasteful consumption of the ink is prevented as well.

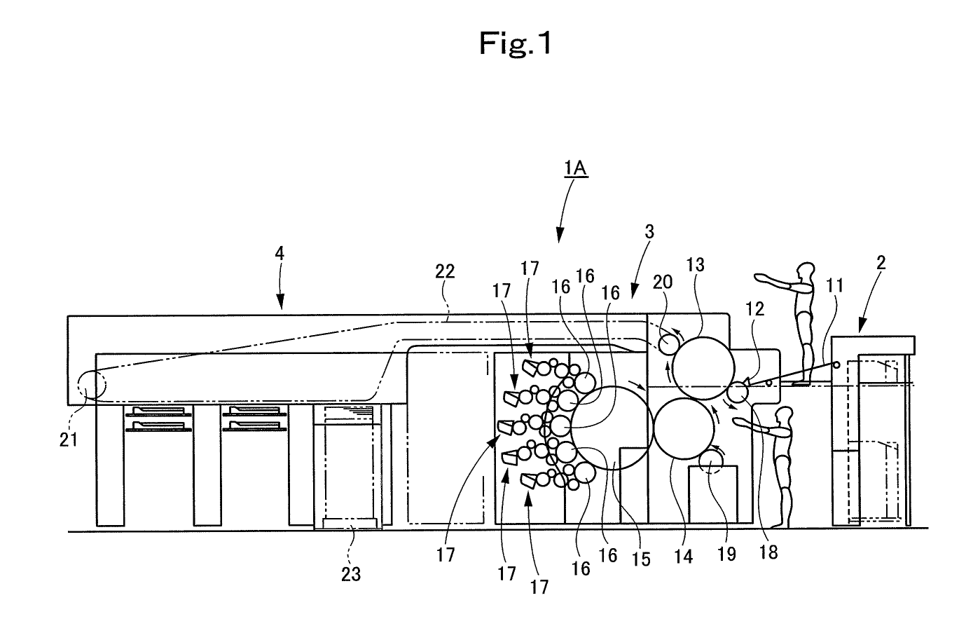

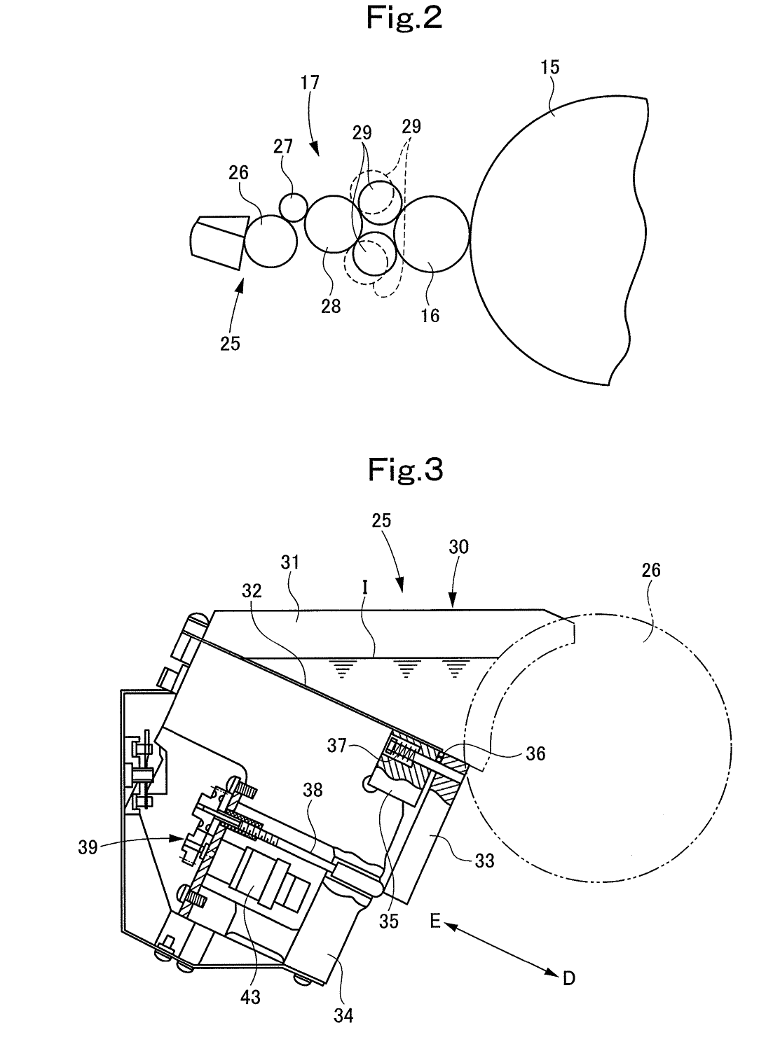

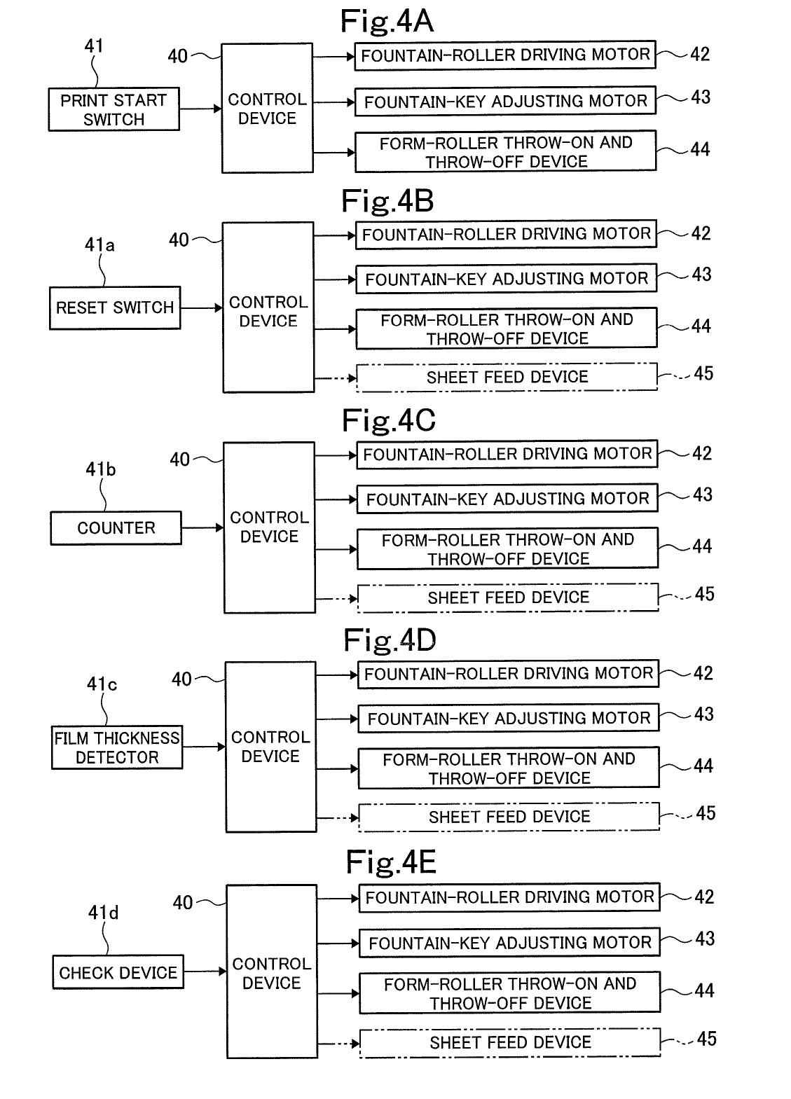

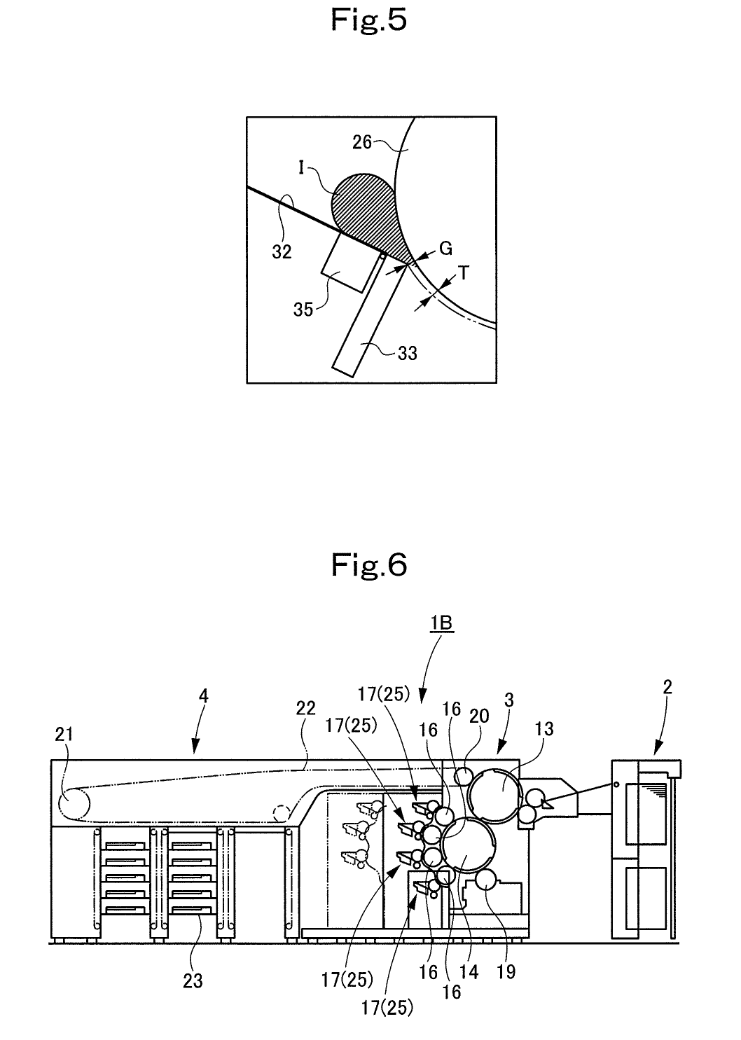

### BRIEF DESCRIPTION OF THE DRAWINGS

[FIG. 1] FIG. 1 is a schematic view of the overall structure of an indirect intaglio printing press showing one embodiment of the present invention.

[FIG. 2] FIG. 2 is an enlarged view of an inking device section.

[FIG. 3] FIG. 3 is a detailed view of an ink fountain device section.

[FIG. 4A] FIG. 4A is a block diagram for control of fountain return during slower operation.

[FIG. 4B] FIG. 4B is a block diagram for the control of the fountain return during normal operation.

[FIG. 4C] FIG. 4C is a modification of the block diagram for the control of the fountain return during the normal operation.

[FIG. 4D] FIG. 4D is a modification of the block diagram for the control of the fountain return during the normal operation.

[FIG. 4E] FIG. 4E is a modification of the block diagram for the control of the fountain return during the normal operation.

[FIG. 5] FIG. 5 is a view describing the fountain return.

[FIG. 6] FIG. 6 is a view describing an example of application to a direct intaglio printing press.

[FIG. 7] FIG. 7 is a diagram describing how an ink residue is generated.

### MODES FOR CARRYING OUT THE INVENTION

An intaglio printing press according to the present invention will be described below in detail through an embodiment with reference to drawings.

### Embodiment

FIG. 1 is a schematic view of the overall structure of an indirect intaglio printing press showing one embodiment of the present invention. FIG. 2 is an enlarged view of an inking device section. FIG. 3 is a detailed view of an ink fountain device section. FIGS. 4A to 4E are block diagrams for control of fountain return in various situations. FIG. 5 is a view describing the fountain return. FIG. 6 is a view describing an example of application to a direct intaglio printing press.

The indirect intaglio printing press, whose overall structure is shown in FIG. 1 by reference numeral 1A, mainly includes: a feed device 2 configured to feed paper sheets W (see FIG. 7), which are stored as stacked sheets, one by one; a printing unit 3 configured to print the fed paper sheets W; and a delivery device 4 configured to deliver the printed paper sheets W. The paper sheets W fed one by one from the feed device 2 onto a feedboard 11 are each gripped by a gripper of a swing arm pregripper 12 while its movement in the lengthwise direction and the widthwise direction is restricted by a registration device whose illustration is omitted.

The printing unit 3 mainly includes: an impression cylinder 13 as a triple-size cylinder; a plate cylinder (intaglio cylinder) 14 as a triple-size cylinder which faces the impression cylinder 13 and on which three plates are mounted side by side in the circumferential direction; an ink collecting cylinder 15 as a quadruple-side cylinder facing the plate cylinder 14; five chablon rollers (partial plate cylinders) 16 as single-size cylinders facing the ink collecting cylinder 15; and inking devices 17 configured to supply inks onto the chablon rollers 16.

In FIG. 1, reference numeral 18 denotes a transfer cylinder facing the impression cylinder 13 and configured to change the grip on the paper sheet W from the swing arm pregripper 12 to a gripper of the impression cylinder 13. Reference numeral 19 denotes a wiping roller contacting the plates of the plate cylinder 14. Reference numeral 20 denotes a delivery cylinder facing the impression cylinder 13, and a delivery chain 22 is laid between a sprocket (not shown) provided coaxially with the delivery cylinder 20 and a sprocket 21 provided in a rear section of the delivery device 4.

In the indirect intaglio printing press 1 with the above structure, the paper sheet W fed onto the feedboard 11 from the feed device 2 is transported while its grip is changed from the swing arm pregripper 12 to the gripper of the impression cylinder 13 through the transfer cylinder 18. At the same time, the ink of each inking device 17 is transferred onto the ink collecting cylinder 15 through the corresponding chablon roller 16 and supplied onto the plate surface of the plate cylinder 14, and an excess portion of the supplied ink is removed by the wiping roller 19.

Thus, the paper sheet W transported by being gripped by the gripper of the impression cylinder 13 is printed when passing between the impression cylinder 13 and the intaglio cylinder 14. The grip on the paper sheet W is then changed to a delivery gripper of the delivery chain 22, and the paper sheet W is transported by the running of the delivery chain 22 and dropped and piled onto a pile board 23.

Next, the inking device and an ink fountain device, which are the characteristic features of the present invention, will be described with reference to FIGS. 2 and 3. As shown in FIG. 2, the inking device 17 mentioned above mainly includes : an ink fountain device 25; a ductor roller 27 supported rotatably and contacting an ink fountain roller 26 which is a constituent component of the ink fountain device 25; an oscillating roller 28 supported rotatably and axially movably and contacting the ductor roller 27; and two form rollers 29 contacting the oscillating roller 28 and the chablon roller 16 mentioned above. All the rollers from the ink fountain roller 26 to the form rollers 29 (in this embodiment, the ink fountain roller 26, the ductor roller 27, the oscillating roller 28, and the form rollers 29) are each configured to be dragged and rotated the others by friction.

The form rollers 29 are retained movably between a throw-on position (shown by solid lines in FIG. 2) at which the form rollers 29 contact the oscillating roller 28 and the chablon roller 16 and a throw-off position (shown by dotted lines in FIG. 2) at which the form rollers 29 remain contacting the oscillating roller 28 but are thrown off the chablon roller 16.

As shown in FIG. 3, the above ink fountain device 25 includes an ink fountain 30 in which ink I is stored, and the ink fountain roller 26 rotatably supported in front of the ink fountain 30. The ink fountain 30 is formed by being surrounded by a pair of left and right ink dams 31 (a pair disposed side by side in the front-back direction of the sheet of FIG. 3), a bottom plate 32, ink fountain keys 33, and the peripheral surface of the ink fountain roller 26, and the ink I is stored therein.

Also, a retaining bar 35 is mounted on an ink fountain key stand 34 in such a way as to extend in the axial direction of the ink fountain roller 26. There are many ink fountain keys 33 disposed in the proximity of the peripheral surface of the ink fountain roller 26 and provided side by side in the axial direction of the ink fountain roller 26. A fulcrum pin 36 is formed to be as long as the retaining bar 35, and each ink fountain key 33 is pulled by the elastic force of a disc spring 37 and retained on the retaining bar 35 with the fulcrum pin 36 therebetween. The ink fountain key 33 is provided with a concave groove (not shown) formed in such a circular shape as to be in sliding contact with a slide surface on the fulcrum pin 36.

Thus, the ink fountain keys 33 are supported on the retaining bar 35 swingably about the slide surface of the fulcrum pin 36 as the fulcrum of the swing. Swinging each of the ink fountain keys 33 changes the gap between itself and the peripheral surface of the ink fountain roller 26, so that the amount of ink supply is adjusted. The ink fountain keys 33 are swung by forward and backward movement (see arrows E, D) of their respective ink-fountain-key opening-closing screw rods 38. Each ink-fountain-key opening-closing screw rod 38 moves forward or backward when rotation of an ink-fountain-key adjusting motor (ink-fountain-key adjusting means) 43 is transferred thereto through a gear mechanism 39.

Moreover, in this embodiment, the indirect intaglio printing press 1A includes a control device 40 configured to control the drive of the above-mentioned ink-fountain-key adjusting motor 43 and a later-mentioned ink-fountain-roller driving motor (ink-fountain-roller driving means) 42 in such a way as to rotationally drive the ink fountain roller 26 with each ink fountain key 33 closed for a predetermined period of time after the printing press is operated but before the paper sheet W is printed, and also to control the drive of a later-mentioned form-roller throw-on and throw-off device 44 during the above period, the form-roller throw-on and throw-off device 44 being configured to move the above-mentioned form rollers 29 between the throw-on position and the throw-off position.

Specifically, as shown in FIG. 4A, a print start switch 41, which is operated by the operator, inputs a signal into the control device 40, which is a microcomputer or the like, and, in a predetermined time after receiving the signal (i.e. in a predetermined period during slower operation of the printing press), the control device 40 outputs drive signals to the ink-fountain-roller driving motor 42, the ink-fountain-key adjusting motor 43, and the form-roller throw-on and throw-off device 44. Note that as the form-roller throw-on and throw-off device 44, a device publicly known, for example from Patent Document 1, is used which includes an air cylinder, brackets, and the like.

With the control device 40 configured as above, each ink fountain key 33 in the ink fountain device 25 is closed by the ink-fountain-key adjusting motor 43 through the ink-fountain-key opening-closing screw rod 38 (the amount of opening of the ink fountain key 33 is set to zero) and the ink fountain roller 26, the ductor roller 27, the oscillating roller 28, and the form rollers 29 are rotationally driven by the ink-fountain-roller driving motor 42 at a predetermined rotational speed for a predetermined period of time after the printing press is operated but before the paper sheet W is printed.

Here, while the amount of opening of the ink fountain key 33 is set at zero, the ink fountain key 33 and the ink fountain roller 26 are out of contact with each other. A gap G between the ink fountain key 33 and the ink fountain roller 26 is very nearly zero (narrow). Hence, the amount of the ink I flowing out of the ink fountain 30 onto the ink fountain roller 26 is not zero but is extremely small, so that the ink I is formed into an extremely thin film on the peripheral surface of the ink fountain roller 26 (see FIG. 5).

Thus, the ink I on the ink fountain roller 26 is returned onto the bottom plate 32 of the ink fountain 30 (this will be referred to as “fountain return”). Specifically, even if ink residues are formed in the inking device 17, the ink I on the ink fountain roller 26, the ductor roller 27, the oscillating roller 28, and the form rollers 29 in the inking device 17 is mostly returned into the ink I stored in the ink fountain 30. Hence, the ink I on the ink fountain roller 26, the ductor roller 27, the oscillating roller 28, and the form rollers 29 is thinly leveled (reset).

The control device 40 is configured to subsequently control the drive of the ink-fountain-key adjusting motor 43 after the “fountain return” performed after the printing press is operated but before the paper sheet W is printed, such that the gap G between the ink fountain key 33 and the ink fountain roller 26 can be a key opening degree coinciding with the image information and printing speed.

As a result, in normal operation of the printing press after the slower operation, fine printing is performed owing to an even ink film thickness T. That is, problems caused by ink residues formed on the ink fountain roller 26 are solved.

Also, in this embodiment, during the “fountain return,” the form-roller throw-on and throw-off device 44 throws the form rollers 29 off the chablon roller 16. Hence, all the rollers of the inking device 17 from the ink fountain roller 26 to the form rollers 29 (in this embodiment, the ink fountain roller 26, the ductor roller 27, the oscillating roller 28, and the form rollers 29) are subjected to the “fountain return.” Accordingly, the ink film thickness T is made further even in the inking device 17.

After the “fountain return,” the gap G between the ink fountain key 33 and the ink fountain roller 26 is at a key opening degree appropriate for the image information and printing speed. Hence, the printing press is ready for the printing to be performed, without an ink residue and with the ink film thickness T appropriate for the printing.

The control device 40 according to this embodiment is also configured to control the drive of the above-mentioned ink-fountain-key adjusting motor 43 and ink-fountain-roller driving motor (ink-fountain-roller driving means) 42 in such a way as to rotationally drive the ink fountain roller 26 with each ink fountain key 33 closed (moved to the proximity of the ink fountain roller 26) for a predetermined period of time when the ink film thickness T on the various rollers of the inking device 17 (in this embodiment, the ink fountain roller 26, the ductor roller 27, the oscillating roller 28, and the form rollers 29) exceeds a predetermined thickness during the normal operation of the printing press (i.e. during the state where the printing is performed), and also to control the drive of the form-roller throw-on and throw-off device 44 during the above period, the form-roller throw-on and throw-off device 44 keeping the above-mentioned form rollers 29 contacting the chablon roller 16 rather than being throw off the chablon roller 16.

Specifically, as shown in FIG. 4B, a reset switch (input switch) 41a, which is operated by the operator, inputs a signal into the control device 40, which is a microcomputer or the like, and, for a predetermined period of time after receiving the signal, the control device 40 outputs the above-mentioned drive signals to the ink-fountain-roller driving motor 42, the ink-fountain-key adjusting motor 43, and the form-roller throw-on and throw-off device 44.

Alternatively, instead of the reset switch 41a, a signal may be inputted into the control device 40 from means for detecting the condition of the ink film thickness T on the form rollers 29 and the like, namely, a counter 41b configured to count the number of printed sheets (see FIG. 4C), a film thickness detector 41c configured to actually detect the ink film thickness T on the form rollers 29 or the like (see FIG. 4D), or a check device 41d configured to check the presence of a sign of poor printing on the sheet (such as increase in printing density) (see FIG. 4E). Note that the film thickness detector 41c detects the ink film thickness T on the form rollers 29 or the like by using a laser displacement gauge, an ultrasonic measurement device, or the like.

With the control device 40 configured as above, when the operator determines during the normal operation that the ink film thickness T on the form rollers 29 and the like has exceeded the predetermined thickness and thus turns on the reset switch (input switch) 41a to input the signal therefrom into the control device 40, each ink fountain key 33 in the ink fountain device 25 is closed by the ink-fountain-key adjusting motor 43 through the ink-fountain-key opening-closing screw rod 38 (the amount of opening of the ink fountain key is set to zero), and the ink fountain roller 26, the ductor roller 27, the oscillating roller 28 and the form rollers 29 are rotationally driven by the ink-fountain-roller driving motor 42 for such a predetermined period of time at such a predetermined rotational speed that the reduced ink film thickness T will not cause poor printing.

Specifically, during printing, the ink fountain roller 26 is rotationally driven while the ink fountain key 33, which adjusts the gap G between itself and the ink fountain roller 26, is moved to the proximity of the ink fountain roller 26 in accordance with the magnitude of the ink film thickness T on the various rollers in the inking device 17 (in this embodiment, the ink fountain roller 26, the ductor roller 27, the oscillating roller 28, and the form rollers 29).

Here, while the amount of opening of the ink fountain key 33 is set at zero, the ink fountain key 33 and the ink fountain roller 26 are out of contact with each other. The gap G between the ink fountain key 33 and the ink fountain roller 26 is very nearly zero (narrow). Hence, the amount of the ink I flowing out of the ink fountain 30 onto the ink fountain roller 26 is not zero but is extremely small, so that the ink I is formed into an extremely thin film on the peripheral surface of the ink fountain roller 26 (see FIG. 5).

Thus, the ink I on the various rollers of the inking device 17 (in this embodiment, the ink fountain roller 26, the ductor roller 27, the oscillating roller 28, and the form rollers 29) is returned onto the bottom plate 32 of the ink fountain 30 (“fountain return”). Specifically, the ink I on the various rollers of the inking device 17 (in this embodiment, the ink fountain roller 26, the ductor roller 27, the oscillating roller 28, and the form rollers 29) is mostly returned into the ink I stored in the ink fountain 30 and is therefore thinly leveled (reset).

Of course, in the intaglio printing press according to the present invention, the key opening degree (the amount of opening of the ink fountain key 33) in the state where the ink fountain key 33 is closed (moved to the proximity) is not limited to zero as in this embodiment. For example, the key opening degree in the “fountain return” may be a half of (50% less than) the set value of the key opening degree during the normal printing operation.

The control device 40 is configured to subsequently control the drive of the ink-fountain-key adjusting motor 43 after the “fountain return” such that the gap G between the ink fountain key 33 and the ink fountain roller 26 can be a key opening degree coinciding with the image information and printing speed.

Generally, during the normal operation of a printing press, the ink I is not transferred onto the various rollers in the inking device 17 (in this embodiment, the ink fountain roller 26, the ductor roller 27, the oscillating roller 28, and the form rollers 29) at positions that coincide with the non-printed portions (notched portions and portions without images) of the chablon roller 16 and the ink film thickness T is large there. This makes the ink film thickness T on the various rollers (in this embodiment, the ink fountain roller 26, the ductor roller 27, the oscillating roller 28, and the form rollers 29) uneven, which may not only cause poor printing but also wasteful consumption of the ink I.

However, by performing the “fountain return” during printing as in this embodiment, the ink film thickness T is even on the various rollers of the inking device 17 (in this embodiment, the ink fountain roller 26, the ductor roller 27, the oscillating roller 28, and the form rollers 29) and allows fine printing. Hence, poor printing resulting from the ink film thickness T in the inking device 17 is prevented, and also the ink film thickness T is not unnecessarily increased and wasteful consumption of the ink I is therefore prevented as well.

Of course, after the “fountain return,” the gap G between the ink fountain key 33 and the ink fountain roller 26 is shifted to a key opening degree appropriate for the image information and printing speed. Hence, the normal operation can be continued with the fine ink film thickness T quickly after the “fountain return.”

In the above embodiment, the example has been described where the “fountain return” is performed without stopping the feed of paper sheets in the feed device 2 during printing (during the normal operation of the printing press). However, it is also possible to perform the “fountain return” after stopping the feed of paper sheets (sheet feed device 45), discharging all the paper sheets inside the press, and then throwing the form rollers 29 of the inking device 17 off the chablon roller 16.

Also, the above embodiment has been described by taking the indirect intaglio printing press 1A as an example. However, as shown in FIG. 6, the present invention may be applied to a direct intaglio printing press 1B in which ink I is transferred onto a chablon roller 16 from an ink fountain device 25 of an inking device 17 and transferred directly onto an intaglio cylinder 14 from a chablon roller 16 without being transferred through an ink collecting cylinder 15. In this way, low viscosity ink I can be handled. Note that in FIG. 6, the same members as those in FIG. 1 are denoted by the same reference numerals and overlapping description thereof is omitted.

Needless to say, the present invention is not limited to the above embodiment and various changes such as changes in the structure of the inking device and in the cylinder diameters of the cylinders can be made without departing from the gist of the present invention.

In the above embodiment, each ink fountain key is closed during the “fountain return.” However, the amount by which the ink fountain key is closed (the amount of movement to the proximity) may be set to any suitable amount. Further, all of the plurality of ink fountain keys may be moved to the same position or moved in the closing direction (to the proximity) as a whole while maintaining the mutual positional relationship that coincides with the image information.

Also, in the above embodiment, each ink fountain key 33 is swung to change the gap G between itself and the ink fountain roller 26. However, for example, the ink fountain key 33 may be formed in the shape of a flat plate sandwiched between the retaining bar 35 and the bottom plate 32, and the gap G between the ink fountain key 33 and the ink fountain roller 26 may be changed by sliding the ink fountain key 33 between the retaining bar 35 and the bottom plate 32. In other words, the ink fountain key and the ink-fountain-key adjusting means in the present invention only need be such that the ink fountain key 33 is movable and the gap G between the ink fountain key 33 and the ink fountain roller 26 can be changed by movement of the ink fountain key 33.

### EXPLANATION OF REFERENCE NUMERALS

1A indirect intaglio printing press

1B direct intaglio printing press

2 feed device

3 printing unit

4 delivery device

11 feedboard

12 swing arm pregripper

13 impression cylinder

14 plate cylinder (intaglio cylinder)

15 ink collecting cylinder

16 chablon roller (partial plate cylinder)

17 inking device

18 transfer cylinder

19 wiping roller

20 delivery cylinder

21 sprocket

22 delivery chain

23 pile board

25 ink fountain device

26 ink fountain roller

27 ductor roller

28 oscillating roller

29 form roller

30 ink fountain

31 ink dam

32 bottom plate

33 ink fountain key

34 ink fountain key stand

35 retaining bar

36 fulcrum pin

37 disc spring

38 ink-fountain-key opening-closing screw rod

39 gear mechanism

40 control device

41 print start switch

42 ink-fountain-roller driving motor (ink-fountain-roller driving means)

43 ink-fountain-key adjusting motor (ink-fountain-key adjusting means)

44 form-roller throw-on and throw-off device

45 sheet feed device

I ink

P plate

W paper sheet (sheet)

C ink residue

G gap between ink fountain key and ink fountain roller

T ink film thickness on various rollers of inking device

1. An intaglio printing press, including
an intaglio cylinder on which a plate is mounted,
a wiping roller configured to wipe an excess portion of ink on the plate by contacting the plate on the intaglio cylinder,
an impression cylinder configured to print a sheet by facing the intaglio cylinder, and
an inking device configured to supply ink directly or indirectly onto the intaglio cylinder,
the inking device including
an ink fountain roller,
ink-fountain-roller driving means for rotationally driving the ink fountain roller,
an ink fountain a front end of which faces the ink fountain roller and which is configured to store ink in cooperation with a peripheral surface of the ink fountain roller,
an ink fountain key movably supported on the front end of the ink fountain and configured to adjust a gap between the ink fountain key and the ink fountain roller, and
ink-fountain-key adjusting means for adjusting an amount of movement of the ink fountain key,
characterized in that the intaglio printing press comprises a control device configured to control the ink-fountain-key adjusting means and the ink-fountain-roller driving means before the sheet is printed, in such a way as to rotationally drive the ink fountain roller with the ink fountain key closed.

2. The intaglio printing press according to claim 1, characterized in that the intaglio printing press is an indirect intaglio printing press comprising:
a plurality of chablon rollers onto which ink is transferred from the inking device; and
an ink collecting cylinder configured to transfer the ink from the plurality of chablon rollers onto the intaglio cylinder.

3. The intaglio printing press according to claim 2, characterized in that
the intaglio printing press further comprises a form-roller throw-on and throw-off device configured to throw form rollers on and off the chablon rollers, and
the control device controls the form-roller throw-on and throw-off device in such a way as to throw the form rollers off the chablon rollers, when rotationally driving the ink fountain roller with the ink fountain key closed before printing is started.

4. The intaglio printing press according to claim 1, characterized in that the control device controls the ink-fountain-key adjusting means and the ink-fountain-roller driving means during printing in such a way as to rotate the ink fountain roller with the ink fountain key moved to a proximity of the ink fountain roller.

5. The intaglio printing press according to claim 4, characterized in that
the intaglio printing press further comprises an input switch configured to start collection of ink, and
the control device controls the ink-fountain-key adjusting means and the ink-fountain-roller driving means based on the input switch.

6. The intaglio printing press according to claim 4, characterized in that
the intaglio printing press further comprises a counter configured to count the number of printed sheets, and
the control device controls the ink-fountain-key adjusting means and the ink-fountain-roller driving means based on the counter.

7. The intaglio printing press according to claim 4, characterized in that
the intaglio printing press further comprises a film thickness detector configured to detect an ink film thickness on the roller of the inking device,
the control device controls the ink-fountain-key adjusting means and the ink-fountain-roller driving means based on the film thickness detector.

8. The intaglio printing press according to claim 4, characterized in that
the intaglio printing press further comprises a check device configured to check a printed sheet, and
the control device controls the ink-fountain-key adjusting means and the ink-fountain-roller driving means based on the check device.

9. An intaglio printing method of printing a sheet by supplying ink from an ink fountain onto an intaglio cylinder through an ink fountain roller while passing the sheet between the intaglio cylinder and an impression cylinder facing the intaglio cylinder, characterized in that the intaglio printing method comprises rotationally driving the ink fountain roller while closing an ink fountain key before the sheet is printed, the ink fountain key being configured to adjust a gap between the ink fountain key and the ink fountain roller.

10. The intaglio printing method according to claim 9, characterized in that the intaglio printing method further comprises rotationally driving the ink fountain roller while moving the ink fountain key to a proximity of the ink fountain roller during printing.
